(19) United States
(12) Patent Application Publication
(10) Pub. No.: US 2002/0087642 A1
(43) Pub. Date: Jul. 4, 2002

(54) Method and apparatus for transferring audio and video files to and from a remote computing system

(76) Inventors: Kevin Hui Wei, Fremont, CA (US); Yoshinari Kiriyama, San Jose, CA (US)

Correspondence Address: Patent Docket Administrator, KATTEN MUCHIN ZAVIS, Suite 1600, 525 West Monroe Street, Chicago, IL, 60661, US

(21) Appl. No.: 09/752,855

(22) Filed: Dec. 28, 2000

Related U.S. Application Data
(60) Provisional application No. 60/239,443, filed on Oct. 11, 2000.

(51) Int. Cl. G06F 15/16; G09G 5/00

(52) U.S. Cl. 709/206; 709/203; 345/748

(57) ABSTRACT

A method of transferring via a networked computing environment a media component from a sender to a recipient includes receiving from the sender a first message having a media component, storing the media component, and sending to the recipient a second message including a link for accessing the media component. A system for implementing such a method may include a message receiver for receiving from the sender via a networked computing environment a first message having a media component, a first storage for storing the media component, and a messaging module for sending a second message to the recipient, the second message including a link for accessing the media component.

### CROSS-REFERENCE TO RELATED APPLICATION

Benefit of U.S. Provisional Patent Application Serial No. 60/239,443, filed on Oct. 11, 2000, is hereby claimed.

### FIELD OF THE INVENTION

The invention relates generally to electronic messaging and, more particularly, to a system and method for providing media such as audio and/or video information in conjunction with electronic messages.

### BACKGROUND OF THE INVENTION

Recent advances in computing and video technology have enabled users to transmit various files over the Internet and other computing networks. These files have included, separately or in combination, text, images, sound, and video.

Electronic mail system users are now able to transfer such files as attachments to e-mail messages. Previously, a user would send an electronic mail message with an attached file to another user who would receive the message and the attached file.

File transfer has also been accomplished through a central computing system or central server. In such a system, a first user would upload a file to the central server and enter information concerning other users who should have access to the uploaded file. Software located on the central server would advise the other users that the uploaded file is available for retrieval. The other users then could retrieve the uploaded file from the central server.

In determining whether to transfer a file in this manner, a user must consider the size of the file, the number of recipients, and the bandwidth and storage constraints on the user and the various recipients. Accordingly, transferring a file in this manner requires the file to be uploaded from the sender's computing system and then downloaded to the recipient's computing system. The transfer of large files with such a system requires substantial bandwidth and transfer time, both for uploading and downloading of the transferred files.

### SUMMARY OF THE INVENTION

The present invention relates to a system that consumes less bandwidth during the downloading of a transferred file than prior file-transfer systems and which thus allows transfer of a media file from a first computing system to a second computing system with less burden on the user of the second computing system than was possible with prior systems (e.g., bandwidth consumption and transfer time).

In one embodiment of the present invention, a first message having a media component is received from the sender of the message, the media component is stored, and a second message including a link for accessing the media component via a networked computing environment is sent to a recipient of the message. The second message may include at least a portion of the first message. Using the link included in the second message, the recipient may retrieve the media component as streaming media or in any other suitable fashion. Preferences of the recipient may be stored such that the recipient can be provided with information based on the preferences (e.g. advertising and/or news of interest to the recipient). Such information may be provided to the recipient when the recipient accesses the media component via the link, or before, after, or during delivery of the media component to the recipient.

The present invention also may be embodied in a system for transferring a media component via a networked computing environment from a sender to a recipient. One embodiment of such a system may include a message receiver for receiving from the sender a first message having a media component, a first storage for storing the media component, and a messaging module for sending a second message to the recipient, the second message including a link for accessing the media component. The system may also provide for retrieval of the media component (as streaming media, for example). The system may also store preferences of the recipient, and provide information to the recipient based on the stored preferences.

### BRIEF DESCRIPTION OF THE DRAWINGS

FIG. 1 depicts one exemplary embodiment of a computing system which may be used to implement the present invention;

FIG. 2 depicts another exemplary embodiment of a computing system which can be used to implement the present invention;

FIG. 3 depicts one exemplary embodiment of a user interface for integrated video capture/transmission software which may be incorporated in or used in conjunction with the present invention;

FIG. 4 depicts one exemplary embodiment of a user interface for video transmission software which may be incorporated in or used in conjunction with the present invention;

FIG. 5 depicts one exemplary embodiment which may be used in connection with a file transfer interface according to the present invention;

FIG. 6 depicts a flowchart of one exemplary process for registering users with a file transfer system according to the present invention;

FIG. 7 depicts a flowchart of one exemplary process for directing additional content to users of a file transfer system according to the present invention; and

FIG. 8 depicts another exemplary embodiment of a computing system which may be used to implement the present invention.

### DETAILED DESCRIPTION OF THE INVENTION

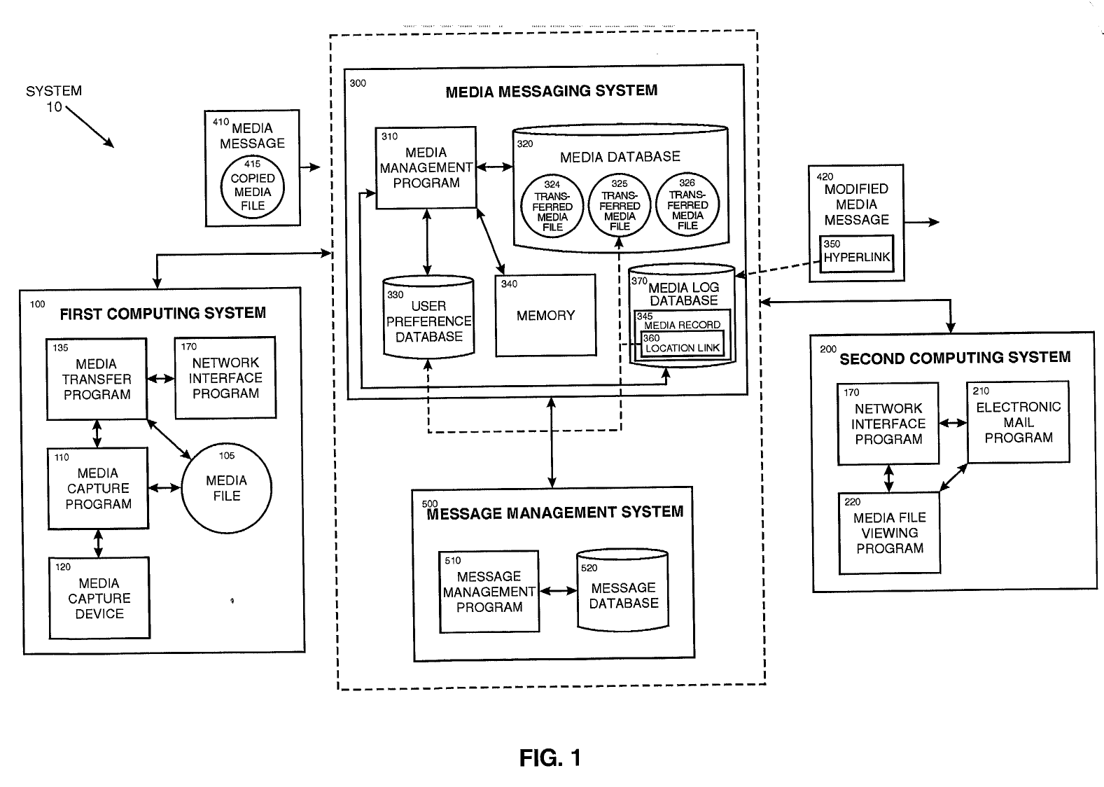

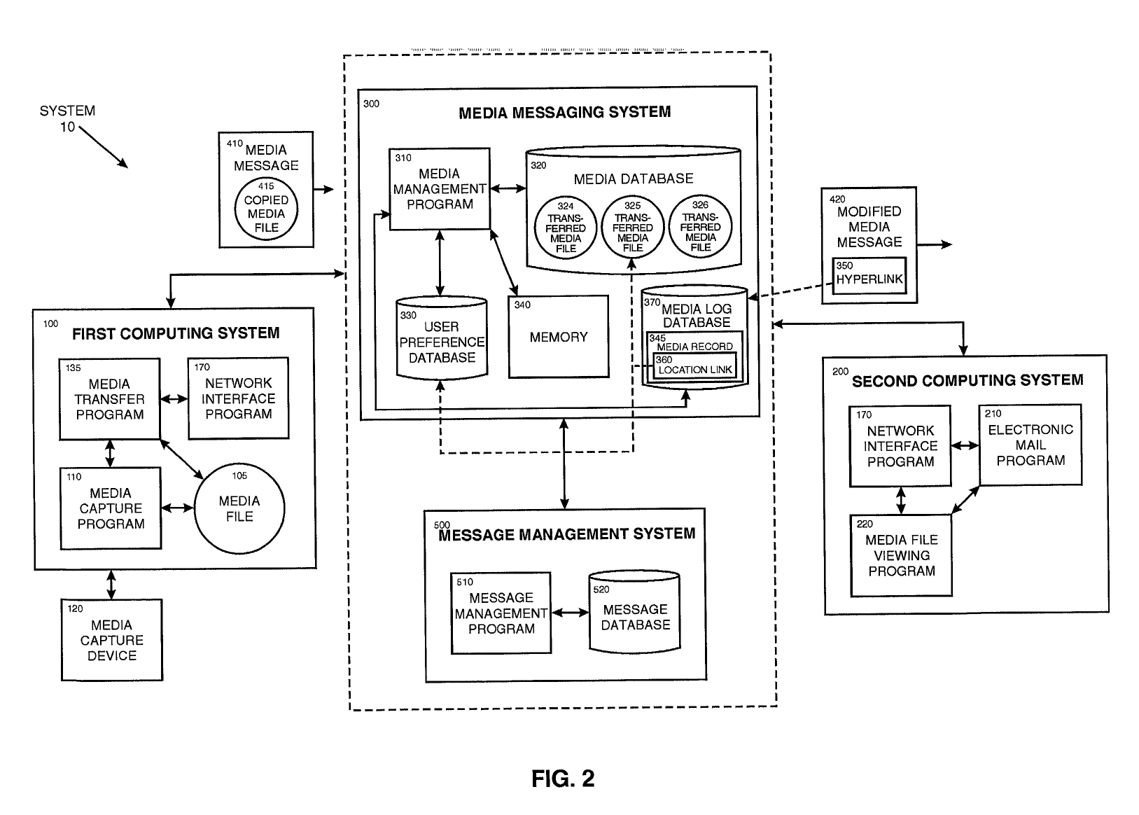

As shown in FIGS. 1 and 2, a system 10 in accordance with the present invention may operate in a networked computing environment, such as the Internet, campus/corporate intranets or extranets. The system 10 of the present invention may include a first computing system 100, a second computing system 200, a media messaging system 300, and a message management system 500. The computing systems 100 and 200 may include any type of input and output devices and are well known in the art. For example, such computing systems 100 and 200 may include personal computers, personal digital assistants, wireless/cellular phones, and pagers.

In one embodiment, the first computing system 100 has a media capture program 110, a media capture device 120, a media transfer program 135, and a network interface program 170 stored thereon. The second computing system 200 includes a network interface program 170, an electronic mail program 210, and a media file viewing program 220. The media messaging system 300 has a media management program 310, a media database 320, a user preference database 330, a memory 340, and a media log database 370. The message management system 500 includes a message management program 510 and a message database 520. The first computing system 100 interacts over the system 10 and is in communication with the media messaging system 300. The media messaging system 300 is in communication with the message management system 500. The second computing system 200 also is in communication with the message management system 500. Such communication is useful for the transfer of video and audio files from the first computing system 100 to the second computing system 200.

First Computing System

As shown in FIGS. 1 and 2, the first computing system 100 includes a media capture program 110, a media capture device 120, a media transfer program 135, and a network interface program 170. The media capture device 120 may be any suitable device for interfacing with a computing system 100, such as a video camera connected through a video capture card or a Universal Serial Bus (USB) port, together with any required software. Those skilled in the art are familiar with techniques for connecting a media capture device 120 to a computing system 100. It should be appreciated that the media capture device 120 may be either wholly or partially contained within the first computing system 100a (FIG. 1) or wholly external to the first computing system 100 (FIG. 2). The media capture program 110 is used to acquire media source information (e.g., audio, video, etc.) from the media capture device 120. The media transfer program 135 is used to transfer a media message 410 from the first computing system 100 to the media messaging system 300. The network interface program 170 is used to provide the first computing system 100 access to the system 10.

Second Computing System

As also shown in FIGS. 1 and 2, the second computing system 200 includes a network interface program 170 and a media file viewing program 220. The network interface program 170 is used to provide the second computing system 200 with access to the system 10. The media file viewing program 220 is used to consume any media file used in the present invention.

Media Messaging System

As also shown in FIGS. 1 and 2, the media messaging system 300 includes a media management program 310, a media database 320, a user preference database 330, a memory 340, and a media log database 370. The media management program 310 manages incoming media messages and transmits messages which allow the user of the second computing system 200 to retrieve the messages. Specifically, the media management program 310 extracts a copied media file 415 from a media message 410, and stores the copied media file 415 as a transferred media file 325 in the media database 320. In the meantime, the media management program 310 will insert into the media log database 370 a media record 345 which includes a location link 360 to the transferred media file 325 and the user preference database 330. It is contemplated that there may be one or more media records 345 located in the media log database 370. The media management program 310 also inserts a hyperlink to the media record 345 in an outgoing message, and transmits the outgoing message to the message management system 500. The hyperlink may be a link to data within the media database 320 (video, audio, text, file) using any type of CGI script, which allows the user to access a file that is contained somewhere within the system 10. Such a CGI script may be, for example, perl, ASP (active server page), JSP (java server script), PHP (personal home page), or C++. The media database 320 contains the transferred media file 325, and is accessed by a message recipient during file retrieval. The user preference database 330 contains information concerning the preferences of users registered with the media messaging system 300. The memory 340 contains any machine instruction used in managing incoming and outgoing messages. It should be appreciated by those skilled in the art that the user preference database 330 could be contained within the memory 340. The media log database 370 may contain a media record 345 concerning the fields that are entered by a message sender, as well as the location from which a transferred media file 325 may be retrieved, user identification information, and a link to the user preference database 330.

Message Management System

The message management system 500 is responsible for receiving messages from the media messaging system 300 or any other computing system within the system 10 and storing the messages until they are retrieved. Such a message management system 500 is well known to those skilled in the art, and may be, for example, a POP3 mail server. The message management program 510 monitors incoming messages sent to electronic mail addresses of particular users. If a message is received for a user, the message management program 510 stores the message in a message database 520. When a user attempts to retrieve his or her messages from the message management system 500, the message management program 510 identifies the user, preferably based upon a user login and password. When a user is authorized to view or retrieve his or her messages, the message management program 510 references the message database 520 to retrieve or make available the messages that belong to that user.

System Operation

When the user of the first computing system 100 (FIG. 1) wishes to transmit a media message 410 to the user of the second computing system 200, the user of the first computing system 100 must first select a media source. The user can either select a media file 105 that is already stored on the first computing system 100, or the user can generate a media file 105 using a media feed provided by the media capture device 120.

The media capture device 120 may be capable of directly providing a media file 105 to the first computing system 100 using an internal media capture program 110, or a media capture program 110 external to the media capture device 120 may be provided. The media capture program 110 acquires the media feed and generates a media file 105. Such a media file 105 may, for example, be a file capable of being viewed with Real Networks' Real Player, Apple's Quicktime, or Microsoft's Windows Media Player. Further, the media file 105 may be a file capable of being viewed in a streaming manner such that the entire media file 105 does not have to be downloaded before the recipient can consume the content.

Alternatively, as illustrated in FIG. 2, if the media capture device 120 is not of a type that is capable of capturing a media feed, the user of the first computing system 100 may employ an external media capture program 110.

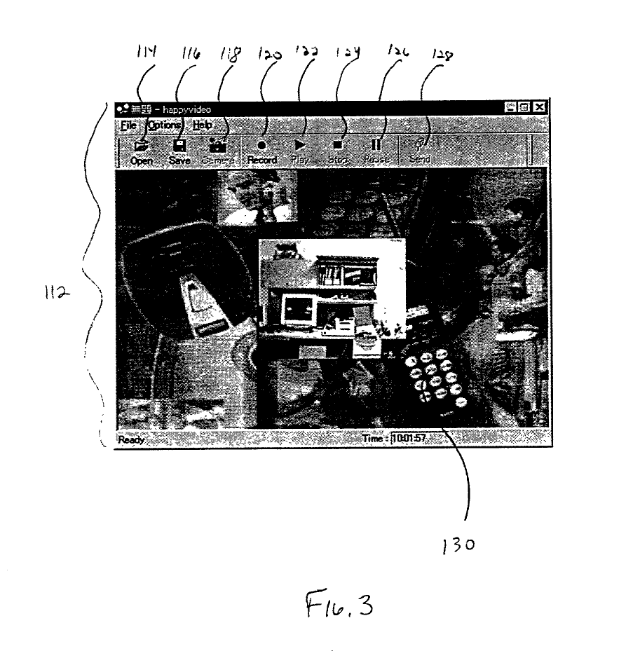

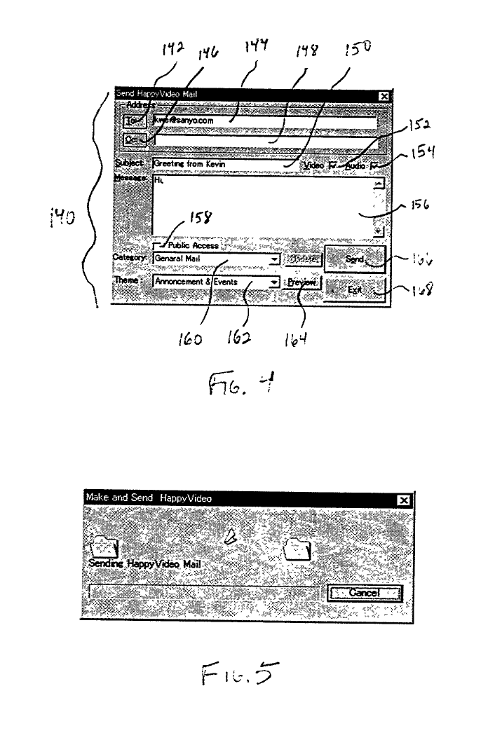

FIG. 3 illustrates one embodiment of a media capture interface 112 associated with a media capture program 110. An “open” button 114, a “save” button 116, a “camera” button 118, a “record” button 120, a “play” button 122, a “stop” button 124, a “pause” button 126, and a “send” button 128 are shown in the illustrated media capture interface 112. Also shown is a media display area 130, in which media files 105 are displayed. The “open” button 114 is used to generate an interface from which the user can select a file to be opened and displayed in the media display area 130. The “save” button 116 is used to save the media file 105 that has been acquired. The “camera” button is used to select the media capture device 120 as the source of the media signal. The “record” button 120 is used to record the incoming media feed from the media capture device 120. The “play” button 122 is used to play a media file 105 so that it is displayed in the media display area 130. The “stop” button 124 is used to stop the playback of the media file 105. The “pause” button 126 is used to pause the playback of the media file 105. The “send” button 128 is used to send the media file 105 to another user, such as the user of the first computing system 200.

Once the user of the first computing system 100 has selected the media file 105 that is to be transferred to the user of the second computing system 200, the user accesses the media transfer program 135, such as by selecting the “send” button 128 in the embodiment depicted in FIG. 3. When the media transfer program 135 is opened, the first computing system 100 generates a media transfer interface 140. The media transfer interface 140 includes a “to” button 142, a “to” data entry field 144, a “cc” button 146, a “cc” data entry field 148, a subject data entry field 150, a “video” check box 152, an “audio” check box 154, a message entry field 156, a “public access” check box 158, a “category” pulldown menu 160, a “theme” pulldown menu 162, a “preview” button 164, a “send” button 166, and an “exit” button 168. The user enters the recipient's electronic mail (e-mail) address in the “to” data entry field 144. The user may also enter other recipients' e-mail addresses in either the “to” data entry field 144 or the “cc” data entry field 148. The user may enter a subject for the message in the “subject” data entry field 150. The user may also determine whether to send the video portion of the file, the audio portion of the file, or both the video and the audio portions of the file through the selection of the “video” check box 152 and the “audio” check box 154. In the message data entry field 156, the user enters a message to be viewed by the recipient. The “public access” check box 158 is selected or checked to indicate that the public should have access to the media file 105, or copies thereof.

The “category” pulldown menu 160 is used to indicate the category to which the message applies. In one embodiment of the present invention, the categories listed in the “category” pulldown menu 160 are dependent upon whether the “public access” check box 158 is selected.

In one exemplary embodiment, categories that are available when the “public access” check box 158 is not selected may include “General Mail,” “Special Video 1, ” and “Special Video 2, ” while those available when the “public access” check box 158 is selected may include “Video Group 1,” “Video Group 2,” and “Video Group 3.” The categories listed in the “category” pulldown menu 160 may determine the themes listed in the “theme” pulldown menu 162.

The “theme” pulldown menu 162 is used to indicate the theme to which the message applies. In one embodiment, as discussed above, the theme is based upon the selected category. For example, under the “General Mail” category, available themes may include “Announcement & Events,” “Birthday,” “Congratulations,” “Good Bye,” “Family Talks,” “Friendship,” “Hello,”“Thank You,” and “Welcome.” Themes available for the “Special Video 1” category may include “Clubs & Events,” “Children & Kids,” “Movies,” “Music,” “Humor,” “Travel & Vacation,” “Song/Karaoke,” “News & Sports,” and “Hobbies.” Other categories may include various other themes which may or may not be particular to the nature of the access, i.e. public or private. These themes may, for example, further include “Advertisement,” “Speech,” “Pets & Animals,” “Holidays,” “Seasonal,” and “Nature.” Those skilled in the art will appreciate that a multitude of categories and themes may be created for use with an embodiment of the present invention.

The “preview” button 164 allows the user to preview the message prior to sending it to the recipient. The “send” button 166 is used when the user is finished creating the message and is ready to send the message to the recipient. The “exit” button is used to exit out of the media transfer interface 140.

When the user selects the “send” button 166, the first computing system 100 determines whether there is a connection to the system 10. If there is not a connection, the first computing system 100 establishes a connection using techniques known to those skilled in the art. Once a connection has been established, a copy of the media file 105 (copied media file 415) is transferred to the media messaging system 300 within the media message 410. It should be appreciated that the media file 105, rather than the copied media file 415, could be transferred to the media messaging system. This transfer may be manifested to the user via a file transfer interface such as that shown in FIG. 5. As shown, a “cancel” button may be provided to enable the user to cancel the transfer, if desired.

It should be appreciated by those skilled in the art that the media message 410 could be sent via electronic mail through the message management system 500 to the media messaging system 300.

The media messaging system 300 receives the media message 410 that was transferred from the first computing system 100. The media management program 310 performs various operations on the media message 410.

The media management program 310 retrieves information contained in the media message 410. For example, the media message 410 generally will include the e-mail address of the intended recipient, as well as the copied media file 415. The media message 410 may further include a subject line, a message, and other information. The media management program 310 extracts the copied media file 415 from the remainder of the message and stores the copied media file 415 in the media database 320 as the transferred media file 325. The media management program 310 determines the location in which it stored the transferred media file 325 and will insert into the media log database 370 a media record 345 which includes a location link 360 to the transferred media file 325 and the user preference database 330. The media management program 310 then generates the modified media message 420 by inserting the hyperlink 350 into the original media message 410, with the copied media file 415 having been removed. The hyperlink 350 is directed to the media record 345. It is foreseen that the hyperlink 350 could point directly to the transferred media file 415 rather than to the media record 345.

After the modified media message 420 is generated, the media management program 310 sends the modified media message 420 to the e-mail address of the intended recipient, via the message management system 500. The message management program 510 stores the modified media message 420 in the message database 520 until the user of the second computing system 200 attempts to retrieve his or her messages. Using techniques known to those skilled in the art, or any other suitable technique, the user of the second computing system 200 retrieves his or her mail messages, including the modified mail message 420. This is preferably done through the use of an electronic mail program 210 or a network interface program 170, such as a web browser.

The user views the modified mail message through an interface associated with the electronic mail program 210 or an interface associated with the network interface program 170. Contained within the modified media message 420 is the hyperlink 350. When the recipient selects or clicks hyperlink 350, the electronic mail program 210 connects to the media messaging system 300. Preferably, the electronic mail program 210 accesses the media record 345 stored on the media messaging system 300. The media record 345 contains the location link 360 to the transferred media file 325 stored in the media database 320 and to the user preference database 330.

When the recipient selects the transferred media file 325 through the location link 360, the second computing system 200 preferably will launch a media file “viewing” program 220. Automatic launching of associated programs based upon file extensions is well-known to those skilled in the art. The media file viewing program 220 generates an interface from which the user of the second computing system 200 may view the transferred media file 325. In one embodiment of the present invention, the transferred media file 325 is provided in a streaming manner. In another embodiment, the user is provided with an option to download the entire transferred media file 325 to the second computing system 200.

The manner in which the transferred media file 325 is viewed may depend upon whether the user has registered with the media messaging system 300.

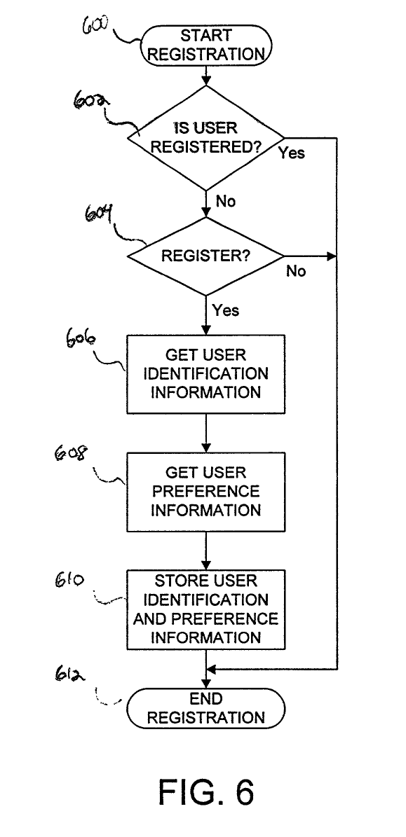

The flowchart of FIG. 6 illustrates one exemplary process by which new users may register with the media messaging system 300. As shown, after a user of the first computing system 100 accesses the media messaging system 300 and starts the registration process (block 600), a determination may be made whether that user is already registered with the media messaging system 300 (block 602). This may be done by comparing identifiers associated with the first computing system 100 against the user preference database 330. If the media management system 300 determines that the user of the first computing system is registered with the system, then no registration is required (block 612) and the registration process of FIG. 6 ends. In one exemplary embodiment, if the media management server 300 determines that the user is not registered, or if the user wishes to register again (e.g., to change the user's identification or preference information), the user is provided with an option to register with the media messaging system 300 through a user interface (block 604). If the user chooses to not register with the media messaging system 300, then no registration takes place and the registration process ends (block 612). If the user chooses to register, then the media messaging system 300 will get user identification information (block 606). Through a user interface, the user may enter identification information such as a username or an e-mail address. Further, the user may be presented with an option to enter a password. An identifier associated with the computing system may also constitute identification information. The user may also be prompted to enter user preference information (block 608). The user preference data may, for example, include age, geographical location, and hobbies or interests. Selections may be made using any suitable method. Some exemplary techniques known to those skilled in the art include pull-down menus, radio buttons, and check-boxes. User identification and preference information is then stored in the user preference database 330 (block 610). After the user identification and preference information is stored, the registration process of FIG. 6 ends.

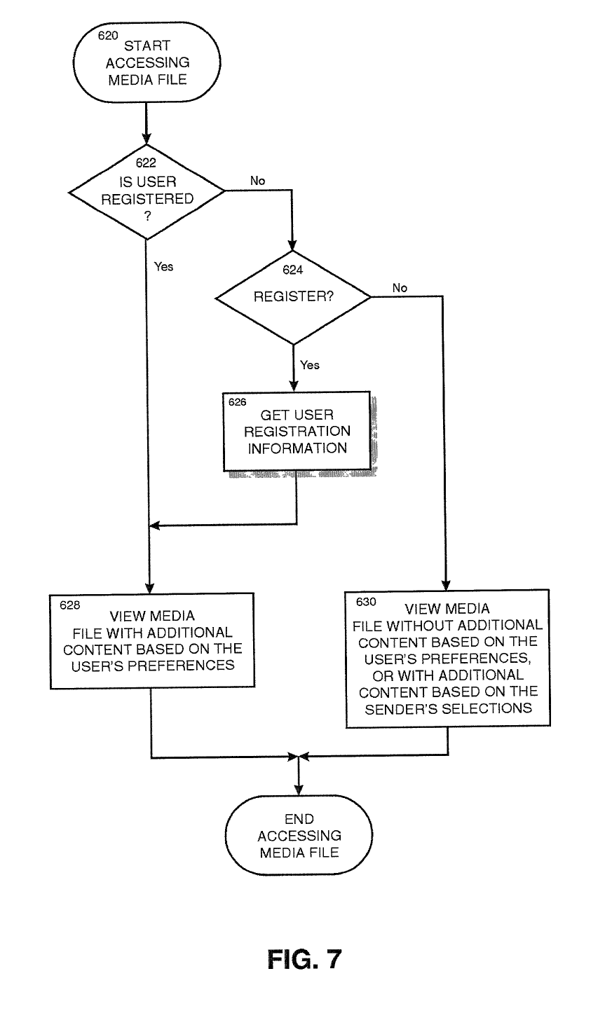

FIG. 7 illustrates one exemplary embodiment of a process in which a user may be provided with additional content based on stored preference data for that user. Upon receiving a modified media message 410 with which a hyperlink 350 is associated, a user may select the hyperlink as explained above to start accessing the transferred media file 325 pointed to by the hyperlink (block 620). The media management program 310 determines if the user is registered with the media messaging system (block 622). If the user is not registered with the media messaging system 300, the user is preferably provided with an option to register (block 624). If the user chooses to register, then registration information is acquired (block 626) in a manner such as that described above in connection with blocks 606, 608, and 610 of FIG. 6.

If the block 622 determines that the user registered previously or if the block 624 determines that the user chose to register when the user attempted to access the media file 105, the user preference database 330 will contain preference data about the user. In one embodiment of the present invention, the media management program 310 then presents the user with additional content related to the user's preference data (block 628). The additional content may, for example, be advertisements or news relating to subjects of interest to the user. The additional content may be presented before the transferred media file 325 is viewed, or after the transferred media file 325 is viewed. The additional content may also or alternatively be viewed while the transferred media file 325 is being viewed. This could be done, for example, by providing one or more areas for additional content outside of the area in which the transferred media file 325 is viewed. In one exemplary embodiment, one or more forms of additional content are presented to the recipient.

In another exemplary embodiment in which the recipient is registered with the media messaging system 300, the additional content may be randomly selected by the media management program 310. Specifically, the content may be based on the user's preferences as entered in the user preference database 330, or on the category and theme chosen by the sender. For example, if the registered recipient has entered that he is interested in Travel, and the sender chose a theme which is focused on Animals, the recipient will view additional content that is Travel or Animal oriented.

Alternatively, should the user choose not to register (see block 624), the user would be shown the requested transferred media file 325 without any additional preference-based content (block 630). The media management program 310 may choose which additional content, if any, is then presented to the user. In another alternative embodiment, the user would be shown the requested transferred media file 325 with additional preference-based content based upon selections made by the sender in the “category” pulldown menu 160 and the “theme” pulldown menu 162.

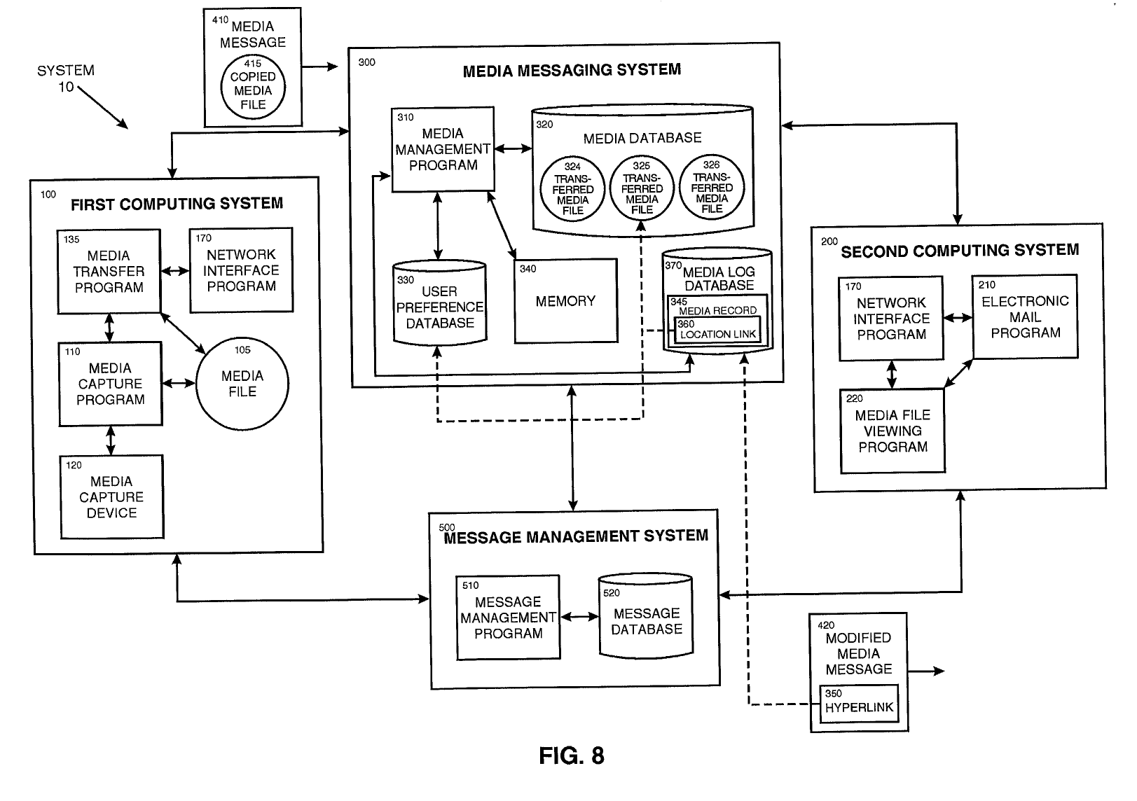

Referring to FIG. 8, another exemplary embodiment of the present invention in which the media messaging system 300 and the message management system 500 are not integrated within a single system. Building non-integrated systems and establishing communication between multiple systems is well known to those skilled in the art of networking.

While the invention has been discussed in terms of one or more embodiments, it should be appreciated by those of skill in the art that the invention is not so limited. The embodiments are explained herein by way of example, and there are numerous modifications, variations and other embodiments that may be employed that would still be within the scope of the claimed invention.

What is claimed is:

1. A method of transferring via a networked computing environment a media component from a sender to a recipient comprising:
receiving from the sender a first message having a media component;
storing the media component; and
sending to the recipient a second message including a link for accessing the media component.

2. The method of claim 1, wherein the media component is stored at a predetermined location.

3. The method of claim 1, wherein the second message includes at least a portion of the first message.

4. The method of claim 1, wherein the media component is retrievable by the recipient.

5. The method of claim 4, wherein the media component is retrievable as streaming media.

6. The method of claim 1, further comprising:
storing preferences of the recipient; and
providing to the recipient information based on the preferences of the recipient.

7. The method of claim 6, wherein the information is provided to the recipient when the recipient accesses the media component via the link.

8. The method of claim 7, wherein the information is provided to the recipient before the recipient receives the media component.

9. The method of claim 7, wherein the information is provided to the recipient after the recipient receives the media component.

10. The method of claim 7, wherein the information is provided to the recipient during at least a portion of the time when the recipient receives the media component.

11. The method of claim 1, further comprising:
storing preferences selected by the sender; and
providing to the recipient information based on the preferences selected by the sender.

12. The method of claim 11, wherein the information comprises at least one of advertising information of interest to the recipient and news of interest to the recipient.

13. A system for transferring via a networked computing environment a media component from a sender to a recipient comprising:
a message receiver adapted to receive from the sender a first message having a media component;
a first storage adapted to store the media component; and
a messaging module adapted to send a second message to the recipient, the second message including a link for accessing the media component.

14. The system of claim 13, wherein the media component is stored at a predetermined location.

15. The system of claim 13, wherein the second message includes at least a portion of the first message.

16. The system of claim 13, wherein the media component is retrievable by the recipient.

17. The system of claim 16, wherein the media component is retrievable by the recipient as streaming media.

18. The system of claim 13, further comprising an information provider adapted to provide to the recipient information based on the preferences of the recipient, wherein the storage is adapted to store preferences of the recipient.

19. The system of claim 18, wherein the information is provided to the recipient when the recipient accesses the media component via the link.

20. The system of claim 19, wherein the information is provided to the recipient before the recipient receives the media component.

21. The system of claim 19, wherein the information is provided to the recipient after the recipient receives the media component.

22. The system of claim 19, wherein the information is provided to the recipient during at least a portion of the time when the recipient receives the media component.

23. The system of claim 13, further comprising an information provider adapted to provide to the recipient information based on the preferences selected by the sender, wherein the storage is adapted to store preferences of the sender.

24. The system of claim 23, wherein the information comprises at least one of advertising information of interest to the recipient and news of interest to the recipient.

25. A system for transferring via a networked computing environment a media component from a sender to a recipient comprising:
a processing unit;
a storage coupled with the processing unit;
a first set of machine instructions storable in the storage and executable by the processing unit for receiving from the sender a first message having a media component;
a second set of machine instructions storable in the storage and executable by the processing unit for storing the media component; and
a third set of machine instructions storable in the storage and executable by the processing unit for sending a second message to the recipient, the second message including a link for accessing the media component.

26. The system of claim 25, wherein the media component is stored at a predetermined location.

27. The system of claim 25, wherein the second message includes at least a portion of the first message.

28. The system of claim 25, wherein the media component is retrievable by the recipient.

29. The system of claim 28, wherein the media component is retrievable as streaming media.

30. The system of claim 25, further comprising:
a fourth set of machine instructions storable in the storage and executable by the processing unit for storing preferences of the recipient; and
a fifth set of machine instructions storable in the storage and executable by the processing unit for providing to the recipient information based on the preferences of the recipient.

31. The system of claim 30, wherein the information is provided to the recipient when the recipient accesses the media component via the link.

32. The system of claim 31, wherein the information is provided to the recipient before the recipient receives the media component.

33. The system of claim 31, wherein the information is provided to the recipient after the recipient receives the media component.

34. The system of claim 31, wherein the information is provided to the recipient during at least a portion of the time when the recipient receives the media component.

35. The system of claim 25, further comprising:
a sixth set of machine instructions storable in the storage and executable by the processing unit for storing preferences selected by the sender; and
a seventh set of machine instructions storable in the storage and executable by the processing unit for providing to the recipient information based on the preferences selected by the sender.

36. The system of claim 35, wherein the information comprises at least one of advertising information of interest to the recipient and news of interest to the recipient.

37. A computer-readable media having stored thereon:
a first set of machine instructions controlling the receipt from the sender of a first message having a media component;
a second set of machine instructions controlling the storage of the media component; and
a third set of machine instructions controlling the sending of a second message to the recipient, the second message including a link for accessing the media component.

38. The computer-readable media of claim 37, wherein the second set of machine instructions includes instructions for controlling the storage of the second message at a predetermined location.

39. The computer-readable media of claim 37, wherein the second message includes at least a potion of the first message.

40. The computer-readable media of claim 37, further having stored thereon:
a fourth set of machine instructions controlling the storage of preferences of the recipient; and
a fifth set of machine instructions controlling providing to the recipient information based on the preferences of the recipient.

41. The computer-readable media of claim 37, further having stored thereon:
a sixth set of machine instructions controlling the storage of preferences selected by the sender; and
a seventh set of machine instructions controlling providing to the recipient information based on the preferences selected by the sender.

42. The computer-readable media of claim 41, wherein the information provided by the fifth set of machine instructions comprises at least one of advertising information of interest to the recipient and news of interest to the recipient.
